(19) United States
(12) Patent Application Publication
(10) Pub. No.: US 2024/0399970 A1
(43) Pub. Date: Dec. 5, 2024

(54) AUTOMOTIVE VEHICLE HOOD

(71) Applicant: FCA US LLC, Auburn Hills, MI (US)

(72) Inventor: Gary T. Isom, Sterling Heights, MI (US)

(21) Appl. No.: 18/325,325

(22) Filed: May 30, 2023

(51) Int. Cl. B60R 9/06; B62D 25/10; B62D 25/12

(52) U.S. Cl. CPC B60R 9/065; B62D 25/105; B62D 25/12

(57) ABSTRACT

An automotive vehicle includes an engine compartment as a cargo space with a body defining the engine compartment cargo space. A hood covers the engine compartment cargo space in a closed position. The hood has at least one movable door coupled with the vehicle for movement with respect to the body. The at least one movable door uncovers the cargo space in an open position. The cargo space has a peripheral boundary defined by the body such that an area above the boundary is open to enable unobstructed entry into the cargo space such that the at least one door in its open position is positioned to with respect to the area above the boundary of the body to enable transverse egress and ingress into the cargo space with the at least one door positioned adjacent an imaginary cylinder defined by the boundary extending away from the cargo space.

### FIELD

The present disclosure relates to automobiles and, more particularly, to a closure or hood for the front cargo compartment.

### BACKGROUND

This section provides background information related to the present disclosure which is not necessarily prior art.

With the advent of electric vehicles, the batteries are positioned under the occupant space. Thus, this leaves the front compartment of the vehicle opened for cargo. Thus, a cargo space is available for the users.

In traditional vehicles, the hood opens approximately 45° to 50° with respect to the plane of body to enable a mechanic adequate space to bend over and work on the engine. With the design of the front cargo space, users need to stand over the opening to load and unload cargo. With only a 45° to 50° opening, the users are hitting their heads on the hood or trying to bend down in an attempt to load heavy objects. This causes ergonomical issues which could lead to body issues.

Accordingly, it is desirable to have a hood that opens greater than the 45° to 50° with respect to the body. Also, it is desirable to provide the user with head clearance while loading and unloading the cargo space. Additionally, it is desirable to have the area above the opening clear so that cargo can be placed transversely to the opening into the storage area.

### SUMMARY

This section provides a general summary of the disclosure, and is not a comprehensive disclosure of its full scope or all of its features.

According to a first aspect of the disclosure, an automotive vehicle including an engine compartment as a cargo space comprises a body defining the engine compartment cargo space in a closed position. A hood covers the engine compartment cargo space in a closed position. The hood comprises at least one movable door coupled with the body of the vehicle for movement with respect to the body. The at least one movable door uncovers the cargo space. The cargo space has a peripheral boundary defined by the body such that an area above the boundary is open enabling entry into the cargo space. The at least one door, in its open position, is positioned with respect to the body so that the area above the boundary defined by the body enables transverse egress and ingress into the cargo space with the at least one door positioned adjacent outside of an imaginary cylinder, defined by the boundary, extending away from the cargo space. The hood may include two doors that open along the longitudinal axis of the vehicle. The at least one door may be a rollup door, an accordion door or a bifold door. The two doors may divide the cargo space.

Accordingly, to a second aspect of the disclosure, an automotive vehicle includes a front trunk and a rear trunk comprising a front trunk including a hood covering the front trunk in a closed position. The hood fits into an opening in the body between the fenders, front grill and windshield of the vehicle. The opening defines a periphery in the body having a desired, overall rectangular configuration. The hood comprises at least one movable door. The movable door is coupled with the vehicle for movement with respect to the body. The at least one movable door uncovers the cargo space, in an open position, such that an area above the overall rectangular configuration is open, unobstructed by the hood, enabling entry into the cargo space. The at least one door, in its open position, is positioned with respect to the overall rectangular configuration to enable unobstructed transverse egress and ingress into the cargo space. The hood may include two doors that open along the longitudinal axis of the vehicle. The at least one door may be a rollup door, an accordion door or a bifold door. The two doors may divide the cargo space.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle with the hood closed in accordance with the disclosure.

FIG. 2 is a view like FIG. 1 with the hood in an open position.

FIG. 3 is a perspective view of an alternative embodiment.

FIG. 4 is a perspective view of another embodiment.

FIG. 5 is a perspective view of a vehicle with an additional embodiment.

FIG. 6 is a perspective view of a vehicle of a vehicle with an alternative embodiment.

FIG. 7 is a perspective view of a vehicle with the hood closed in accordance with the disclosure.

FIG. 8 is a side elevation view of the vehicle of FIG. 7 with the hood in an open position in phantom.

FIG. 9 is a front elevation view of the vehicle of FIG. 7 with the hood in an open position.

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle generally includes a front trunk or cargo space 12 covered by a hood 14. The hood 14 is positioned between a front grill 16, fenders 18 and windshield 20.

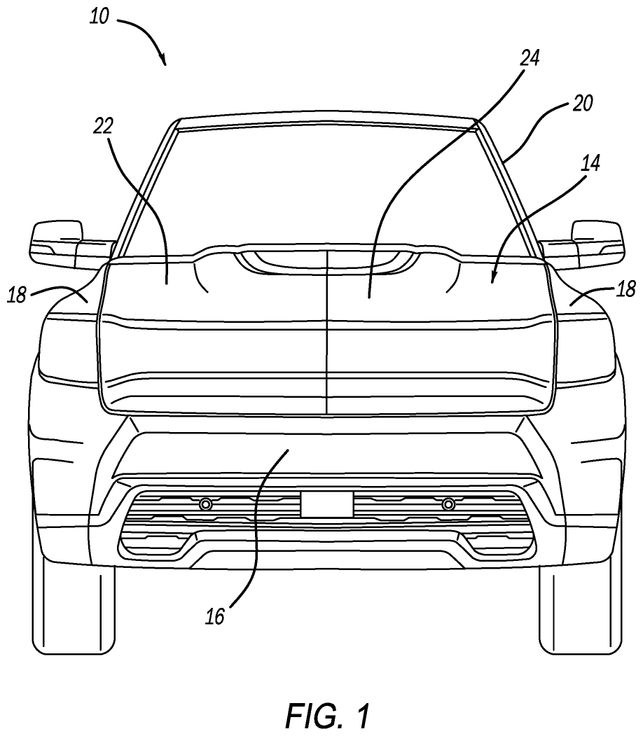

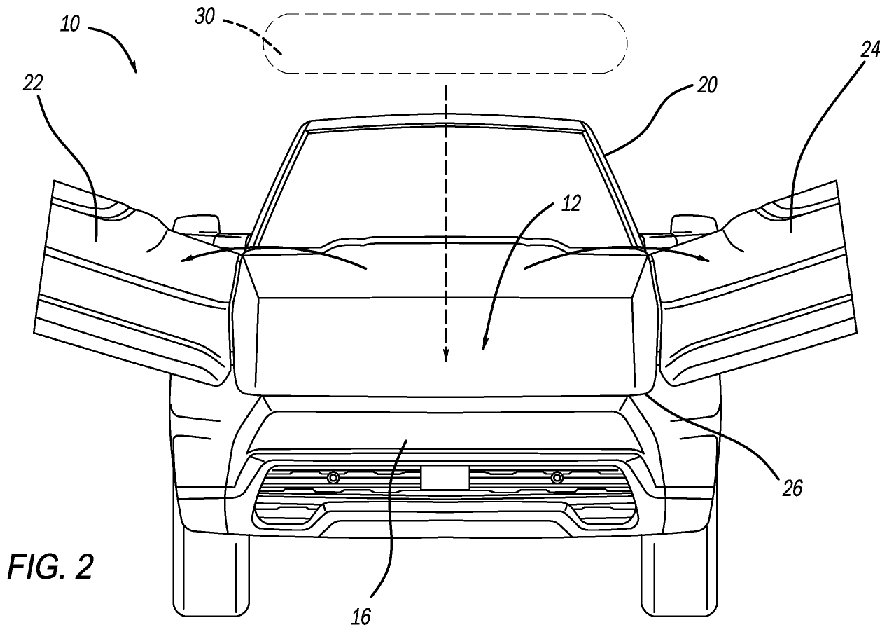

In FIGS. 1 and 2, the hood 14 is divided into a pair of doors 22, 24. The doors 22, 24 are coupled with the vehicle on sides adjacent the fenders 18. Thus, the doors 22, 24 open with respect to a longitudinal axis of the vehicle 10 towards the fenders 18 providing access to the cargo area 12. The body opening 26 defined by the fenders between the front grill and windshield receives the hood. The hood fits in the opening in the body between the fenders grille windshield of the vehicle. The opening defines a periphery in the body having a desired overall rectangular configuration.

The movable doors 22, 24 move with respect to the body to uncover the cargo space 12. Thus, an area above the boundary is open to enable unobstructed egress and ingress of cargo into the space 12. In its open position, the doors 22, 24 are positioned with respect to the boundary to enable transverse egress and ingress into the cargo space 12. The door are positioned adjacent an imaginary cylinder 30 defined by the boundary extending away from the cargo space. Thus, one moving cargo to and from the space 12 is not interfered with by the doors nor is the user banging his head on the same.

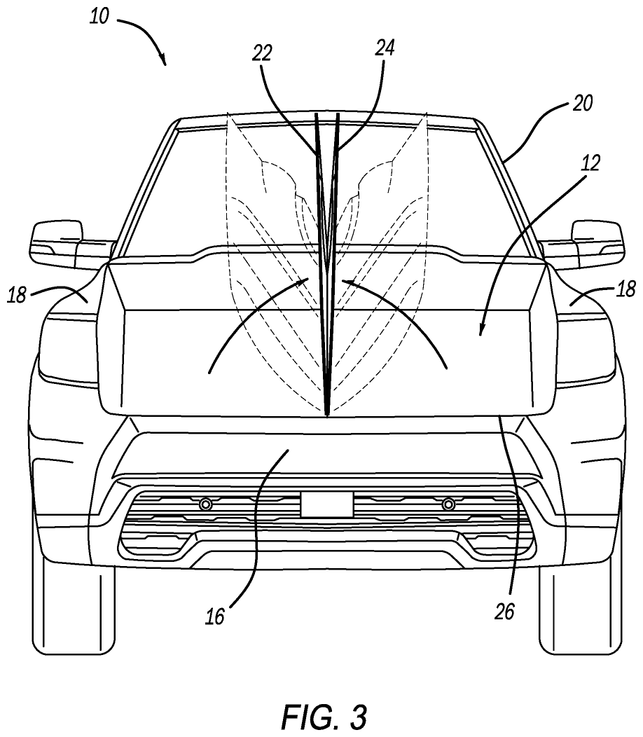

Turning to FIG. 3, an additional embodiment is shown. The like reference numerals identify like or the same parts.

Here, the doors 22, 24 are secured in a position to divide the cargo area 12. The doors 22, 24 may be moved upward, toward, to contact toward another providing the optimum space above the rectangular opening to enable the egress and ingress. Thus, it is desirable that the doors are at an angle of about 90° with respect to the body. The range can be 90° to 120°. Thus the doors open such that an angle is greater than 90° with respect to the body.

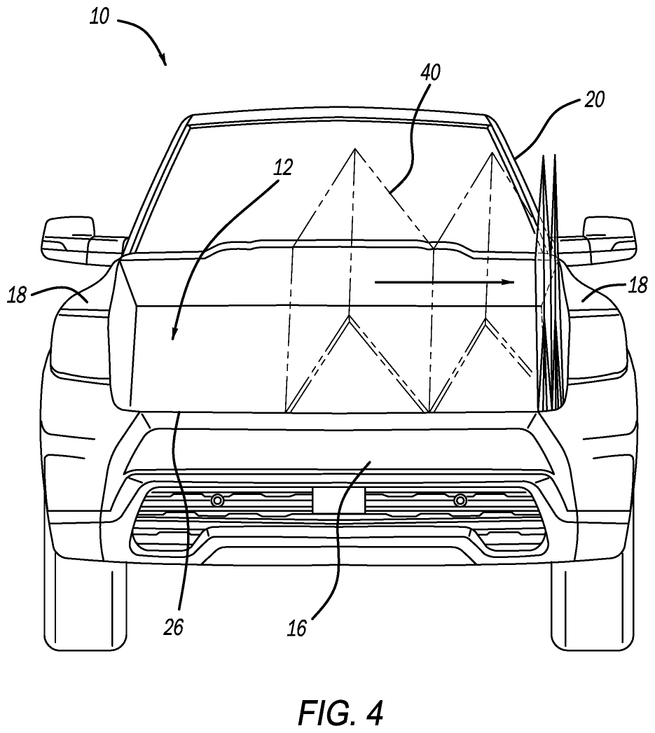

Turning to FIG. 4, an additional embodiment is shown. Like reference numerals are utilized to identify the same or similar parts.

Here, an accordion or bifold door 40 may be utilized to cover the boundary. The door 40 may slide so that it is positioned adjacent an edge of the opening along the longitudinal axis of the opening. Additionally, the bifold door 40 could be positioned so that the door moves from front to back along the longitudinal axis such that it would be transverse to the longitudinal axis, as illustrated in phantom.

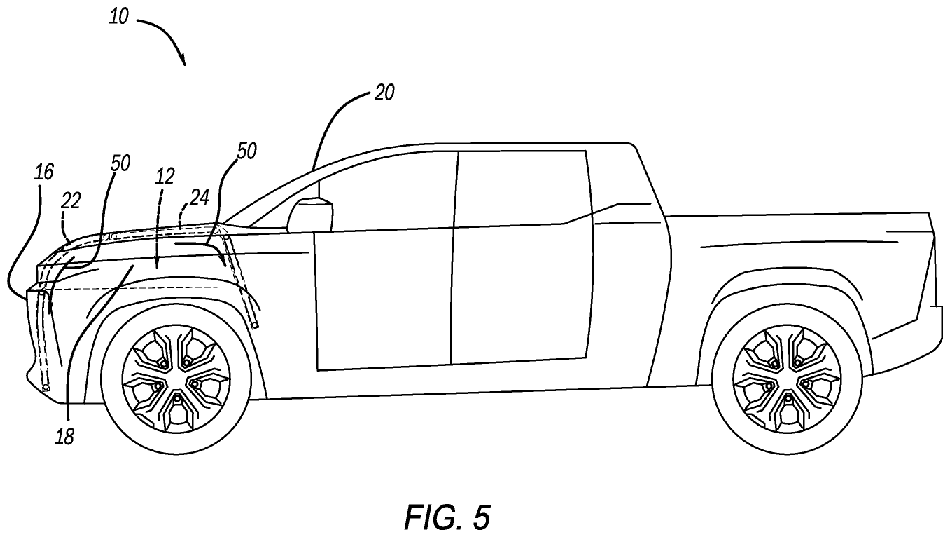

FIG. 5 illustrates an additional embodiment of the disclosure. Thus, like reference numerals identify like elements. Here, the hood includes a rollable door 50 or 60.

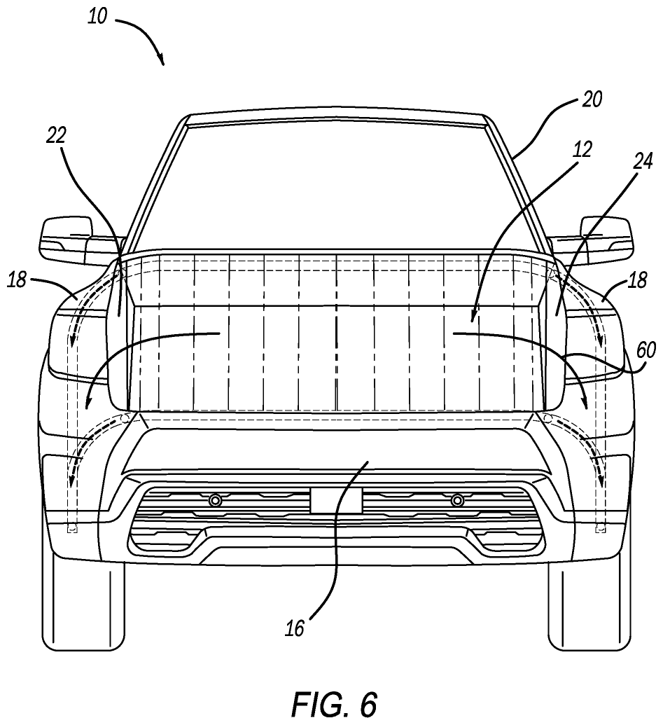

The door 50 may roll toward the windshield or grille and be positioned adjacent the cargo area. Also as illustrated in FIG. 6, the door 60 may roll side to side from fender to fender uncovering the trunk opening. Aldo, as illustrated in phantom, there may be two rolling doors rolling to each fender as illustrated in phantom. Further, the dual rolling doors 60 could roll from the middle of the opening towards the windshield and front grille.

Thus, the present disclosure provides a hood or closure that enables access transverse into the cargo area opening. Accordingly, users would not have the issue of hitting their head and ergonomical bending is available.

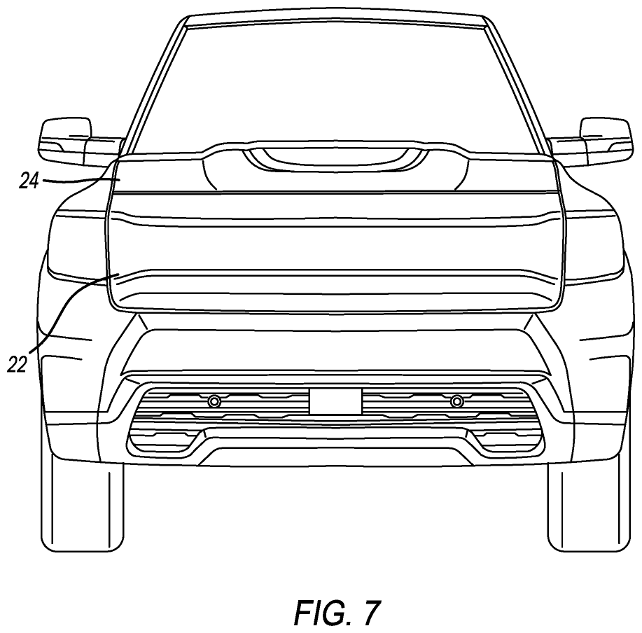

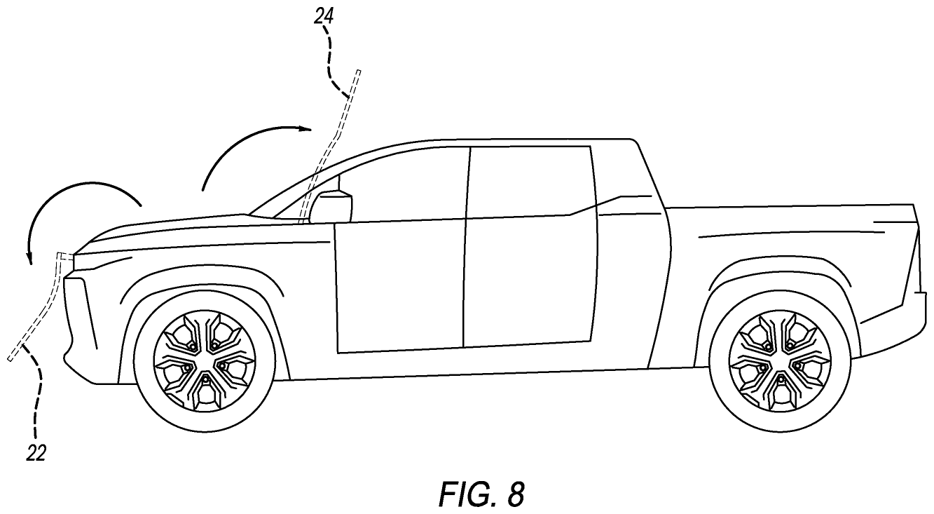

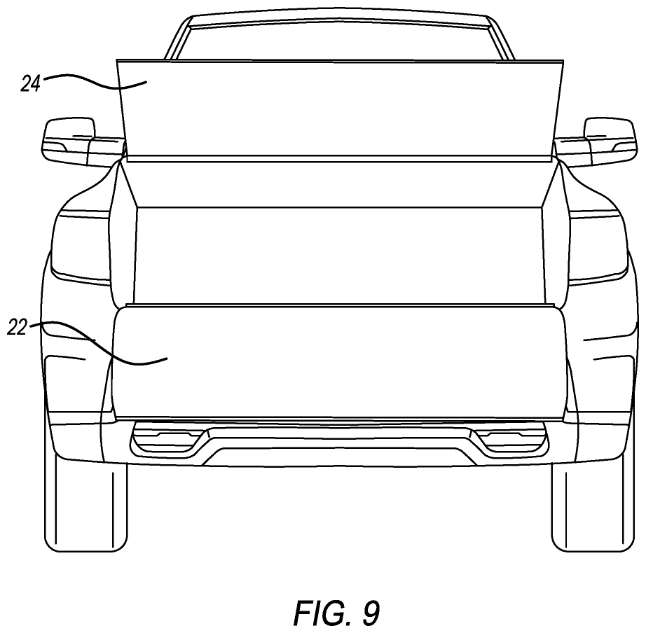

Turning to FIGS. 7-9, the hood 14 is divided into a pair of doors 22, 24. The doors 22, 24 are coupled with the vehicle on the front and rear of the fenders 18. Thus, the doors 22, 24 open perpendicular to a longitudinal axis of the vehicle 10 toward the front grille of the vehicle and toward the windshield. The body opening 26 is defined by the fenders between the front grille and windshield and receives the hood 14. The hood 14 fits in the opening in the body between the fenders, grille and windshield on the vehicle. The opening defines a periphery in the body having a desired overall rectangular configuration.

The movable doors 22, 24 move with respect to the body to uncover the cargo space 12. Thus, in an area above the boundary is open to enable unobstructed egress and ingress of cargo into the space 12. In its open position, the doors 22, 24 are positioned with respect to the boundary to enable transverse egress and ingress into the cargo space 12. Thus with the doors 22, 24 positioned adjacent the grille and the windshield, moving cargo to and from the space is not interfered by the doors. Nor is the user banging his head on the same. The doors are positioned adjacent an imaginary cylinder defined by the boundaries extending away from the cargo space.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An automotive vehicle including an engine compartment as a cargo space comprising:
a body defining the engine compartment cargo space and a hood covering the engine compartment cargo space in a closed position;
the hood comprising at least one movable door, the movable door coupled with the vehicle for movement with respect to the body, the at least one movable door uncovering the cargo space in an open position;
the cargo space having a peripheral boundary defined by the body such that an area above the boundary is open enable unobstructive entry into the cargo space such that the at least one door in its open position is positioned with respect to the area above the boundary of the body to enable transverse egress and ingress into the cargo space with the at least one door positioned adjacent an imaginary cylinder defined by the boundary extending away from the cargo space.

2. The automotive vehicle of claim 1, wherein the hood includes two doors.

3. The automotive vehicle of claim 2, wherein the two doors open along longitudinal axes of the automotive vehicle.

4. The automotive vehicle of claim 1, wherein the at least one door is a roll up door.

5. The automotive vehicle of claim 1, wherein the at least one door is an accordion door.

6. The automotive vehicle of claim 1, wherein the at least one door is a bifold door.

7. The automotive vehicle of claim 2, wherein the two doors divided the cargo space.

8. An automotive vehicle including a front trunk and rear trunk comprising:
the front trunk including a hood, the hood covers the front trunk in a closed position, the hood fits in an opening in the body between fenders, grille and windshield of the vehicle, the opening defines a periphery in the body having a desired, overall rectangular configuration;
the hood comprising at least one movable door, the movable door coupled with the vehicle for movement with respect to the body, the at least one movable door uncovering the cargo space in an open position;
such that an area above the boundary is open enable entry into the cargo space such that the at least one door in its open position is positioned with respect to the area above the boundary of the body to enable transverse egress and ingress into the cargo space with the at least one door positioned adjacent an imaginary cylinder defined by the boundary extending away from the cargo space.

9. The automotive vehicle of claim 1, wherein the hood includes two doors.

10. The automotive vehicle of claim 9, wherein the two doors open along longitudinal axes of the automotive vehicle.

11. The automotive vehicle of claim 1, wherein the at least one door is a roll up door.

12. The automotive vehicle of claim 1, wherein the at least one door is an accordion door.

13. The automotive vehicle of claim 1, wherein the at least one door is a bifold door.

14. The automotive vehicle of claim 9, wherein the two doors divide the cargo space.
